(19) United States
(12) Patent Application Publication
(10) Pub. No.: US 2010/0199688 A1
(43) Pub. Date: Aug. 12, 2010

(54) APPARATUS FOR SUPPLYING LIQUID NITROGEN

(76) Inventors: Choon Dong Kim, Gunpo-si (KR); Su Kil Lee, Gumi-si (KR); Hyun Man Jang, Hwaseong-si (KR); Chang Youl Choi, Gumi-si (KR)

Correspondence Address: SHERR & VAUGHN, PLLC, 620 HERNDON PARKWAY, SUITE 320, HERNDON, VA, 20170, US

(21) Appl. No.: 12/618,909

(22) Filed: Nov. 16, 2009

(30) Foreign Application Priority Data
Feb. 11, 2009 (KR) 10-2009-0011001

(51) Int. Cl. F17C 7/02; F17C 13/00

(52) U.S. Cl. 62/50.1; 62/50.7

(57) ABSTRACT

An apparatus for supplying liquid nitrogen for a decompression device: includes a liquid nitrogen supply line extending such that high-temperature, high-pressure liquid nitrogen is introduced to a decompression device; a bypass pipe diverging from the liquid nitrogen supply line; and an expansion unit installed at the bypass pipe to evaporate the liquid nitrogen into nitrogen gas. The expansion unit is disposed to absorb heat from the liquid nitrogen in the liquid nitrogen supply line before being introduced to the decompression device.

### CROSS-REFERENCE TO RELATED APPLICATION

This application claims priority to Korean Patent Application No. 10-2009-0011001, filed on Feb. 11, 2009, and all the benefits accruing therefrom under 35 U.S.C. §119, the contents of which in its entirety are herein incorporated by reference.

### BACKGROUND

1. Field

This disclosure relates to an apparatus for supplying liquid nitrogen, and more particularly to an apparatus for supplying liquid nitrogen used for a decompression device of a superconducting cable.

2. Description of the Related Art

Superconductivity is a phenomenon that an electric resistance of a conductor becomes zero at ultra-low temperatures, and a superconducting cable is a power cable for realizing such a phenomenon. Liquid nitrogen is used to realize the superconductivity, and a conductor may have superconducting characteristics thanks to an ultra-low temperature of the liquid nitrogen.

Liquid nitrogen is filled while being in contact with a superconductor along a superconducting cable, and a decompression device should be installed to decrease pressure in case an excessive pressure occurs at the liquid nitrogen.

FIG. 1 is a schematic diagram showing how to carry liquid nitrogen of a superconducting cable to a decompression device.

As shown in FIG. 1, in order to supply liquid nitrogen to a decompression device in a vacuum state, a liquid nitrogen supply line 1 extending from a liquid nitrogen tank (not shown) to the decompression device is installed, and a gas-liquid separator 3 storing high-temperature, high-pressure liquid nitrogen is installed at the liquid nitrogen supply line 1. The liquid nitrogen flowing along the liquid nitrogen supply line 1 is stored in the gas-liquid separator 3, and nitrogen gas generated in the gas-liquid separator 3 is discharged to the air, while liquid nitrogen is kept at an atmospheric state and then flowing to the decompression device 5.

Meanwhile, at the rear of the gas-liquid separator 3, a valve 7 is installed at the liquid nitrogen supply line 1 such that the liquid nitrogen in an atmospheric state is supplied to the decompression device 5 or intercepted due to the operation of the valve 7.

Such an apparatus for supplying liquid nitrogen used for a decompression device of a superconducting cable, configured as above, has a complicated structure since the gas-liquid separator 3 should be separately installed to supply liquid nitrogen at an atmospheric pressure, and the installation cost is high. The gas-liquid separator 3 is a vacuum insulating tank, which is expensive.

Also, while liquid nitrogen is filled in the gas-liquid separator 3, a large amount of nitrogen gas is generated and discharged to the air, which increases a maintenance cost.

In addition, an amount of liquid nitrogen introduced into the decompression device 5 is proportional to a difference of pressure. Thus, in order to increase an amount of liquid nitrogen, the pressure in the gas-liquid separator 3 should be increased by installing the gas-liquid separator 3 higher than the decompression device 5, or installing a valve to a discharge line 9 that is mounted to the gas-liquid separator 3 to discharge interior nitrogen gas to the air.

### SUMMARY

The following disclosure is designed to solve the above problems, and therefore there is provided an apparatus for supplying liquid nitrogen for a decompression device of a superconducting cable, which does not need a vacuum-insulated gas-liquid separator and thus has a simple design to reduce a manufacture cost and allows to prevent waste of nitrogen gas.

In one aspect, there is provided an apparatus for supplying liquid nitrogen for a decompression device, which includes: a liquid nitrogen supply line extending such that high-temperature, high-pressure liquid nitrogen is introduced to a decompression device; a bypass pipe diverging from the liquid nitrogen supply line; and an expansion unit installed at the bypass pipe to evaporate the liquid nitrogen into nitrogen gas. Here, the expansion unit is disposed to absorb heat from the liquid nitrogen in the liquid nitrogen supply line before being introduced to the decompression device.

Further, the liquid nitrogen supply line may pass through the expansion unit or may be disposed adjacent to the expansion unit.

Further, a first valve for opening or closing the liquid nitrogen supply line may be installed at the liquid nitrogen supply line.

In addition, a second valve for opening or closing the bypass pipe may be further installed at the bypass pipe.

Further, an exhaust pipe may extend from the expansion unit.

In addition, the first valve and the second valve may be configured to be opened or closed together.

Further, the nitrogen gas may be at an atmospheric pressure.

As described above, the apparatus for supplying liquid nitrogen for a decompression device of a superconducting cable disclosed herein may be directly connected to high-temperature, high-pressure liquid nitrogen supply line. Therefore, no additional gas-liquid separator is required. In case of the gas-liquid separator, a certain amount of liquid nitrogen should be filled at ordinary times, but the liquid nitrogen filled in the gas-liquid separator is evaporated due to the external heat, which increases the consumption of liquid nitrogen. However, the apparatus for supplying liquid nitrogen for a decompression device disclosed herein evaporates and discharges liquid nitrogen only during decompression, so the consumption of liquid nitrogen may be decreased.

Further, the apparatus for supplying liquid nitrogen for a decompression device disclosed herein is kept at a high temperature even at a front end of the valve, so there is no limit in its installation caused by pressure difference.

In addition, in the apparatus for supplying liquid nitrogen for a decompression device disclosed herein, in case a separate valve is mounted to a bypass pipe, the decompression device may be operated rapidly by cooling the expansion unit in advance.

### BRIEF DESCRIPTION OF THE DRAWINGS

FIG. 1 is a schematic view showing a general decompression device of a superconducting cable.

FIG. 2 is a schematic view showing an apparatus for supplying liquid nitrogen for a decompression device of a superconducting cable according to one embodiment disclosed herein.

FIG. 3 is a schematic view showing an apparatus for supplying liquid nitrogen for a decompression device of a superconducting cable according to another embodiment disclosed herein.

### REFERENCE NUMERALS OF ESSENTIAL PARTS IN THE DRAWINGS

| | | | |
|---|---|---|---|
| 100: | liquid nitrogen supplying | 110: | liquid nitrogen supply line |
| | apparatus | | |
| 111: | first valve | 120: | coolant circulating line |
| 130: | expansion unit | 131: | exhaust pipe |
| 140: | bypass pipe | 142: | second valve |
| 150: | decompression device | | |

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

Hereinafter, an apparatus for supplying liquid nitrogen for a decompression device of a superconducting cable according to an embodiment disclosed herein will be explained in detail with reference to the accompanying drawings.

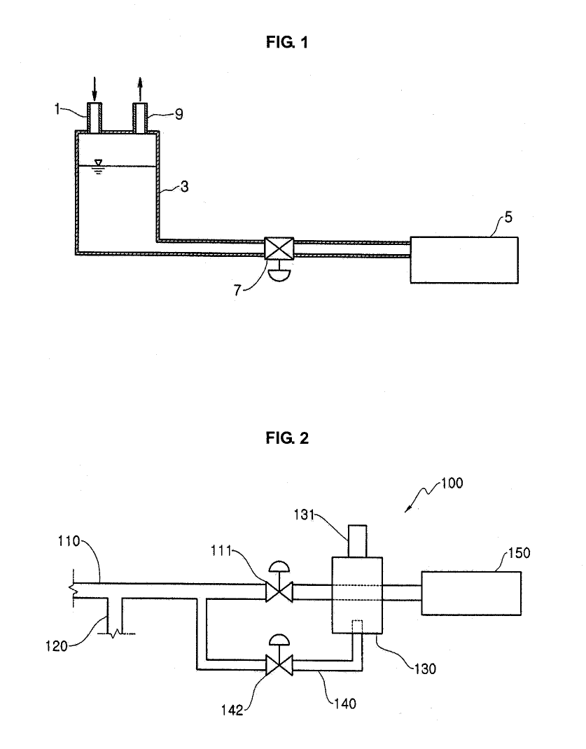

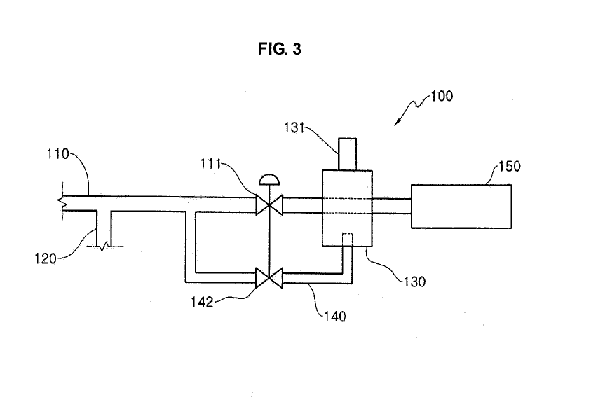

FIG. 2 is a schematic view showing an apparatus for supplying liquid nitrogen for a decompression device of a superconducting cable according to one embodiment disclosed herein, and FIG. 3 is a schematic view showing an apparatus for supplying liquid nitrogen for a decompression device of a superconducting cable according to another embodiment disclosed herein.

As shown in FIG. 2, the apparatus 100 for supplying liquid nitrogen for a decompression device of a superconducting cable includes a liquid nitrogen supply line 110 for supplying high-temperature, high-pressure liquid nitrogen introduced from a liquid nitrogen tank (not shown) to a decompression device 150, and a coolant circulating line 120 diverging from the liquid nitrogen supply line 110. An expansion unit 130 is installed at the liquid nitrogen supply line 110, and the liquid nitrogen supply line 110 passes through the expansion unit 130. A bypass pipe 140 connected to the expansion unit 130 diverges from the liquid nitrogen supply line 110. A first valve 111 is installed at the liquid nitrogen supply line 110 to open or close the liquid nitrogen supply line 110, and a second valve 142 is installed at the bypass pipe 140 to open or close the bypass pipe 140.

Hereinafter, the apparatus for supplying liquid nitrogen for a decompression device of a superconducting cable configured as above is described in detail.

The liquid nitrogen supply line 110 extends to the decompression device 150 such that liquid nitrogen is introduced from the liquid nitrogen tank and then flows to the decompression device 150. The first valve 111 is mounted at an intermediate location of the liquid nitrogen supply line 110, and the bypass pipe 140 diverges from the liquid nitrogen supply line 110 at the front of the first valve 111. At the front of the bypass pipe 140, the coolant circulating line 120 diverges from the liquid nitrogen supply line 110. The coolant circulating line 120 is configured such that the liquid nitrogen introduced to the liquid nitrogen supply line 110 is supplied to a superconducting cable and then circulated.

At the rear of the first valve 111, the liquid nitrogen supply line 110 passes through the expansion unit 130. Here, the bypass pipe 140 extends to the expansion unit 130, and the second valve 142 is mounted at the bypass pipe 140.

Thus, at ordinary times, the first valve 111 and the second valve 142 respectively close the liquid nitrogen supply line 110 and the bypass pipe 140, so the liquid nitrogen introduced to the liquid nitrogen supply line 110 is discharged to the superconducting cable through the coolant circulating line 120 and then circulated. However, if it is required to decrease pressure, the second valve 142 is opened such that the liquid nitrogen in the liquid nitrogen supply line 110 is flown to the expansion unit 130 through the bypass pipe 140. The liquid nitrogen at 10 bars or lower, introduced to the expansion unit 130, is expanded and evaporated into nitrogen gas at an atmospheric pressure, during which an evaporation heat is absorbed.

At this time, the first valve 111 is opened such that high-temperature, high-pressure liquid nitrogen passes through the expansion unit 130. Then, the liquid nitrogen is evaporated into nitrogen gas at the expansion unit 130 such that the expansion unit 130 may absorb heat from the liquid nitrogen passing through the expansion unit 130 along the liquid nitrogen supply line 110. The liquid nitrogen passing through the expansion unit 130 is introduced to the decompression device 150 in a cooled state.

The nitrogen gas evaporated at the expansion unit 130 is discharged to the air through an exhaust pipe 131 mounted at the expansion unit 130. The liquid nitrogen supply line 110 may pass through the expansion unit 130, but the liquid nitrogen supply line 110 may also be disposed adjacent to the expansion unit 130.

It has been illustrated in the apparatus 100 for supplying liquid nitrogen for a decompression device of a superconducting cable that the first and second valves 111, 142 are respectively mounted at the bypass pipe 140 and the liquid nitrogen supply line 110 to be operated individually, but the valve structure may be modified into various ways, not limited to the above.

In other words, since the liquid nitrogen supply line 110 is opened substantially at the same time as the bypass pipe 140 is opened, a valve for opening or closing the liquid nitrogen supply line 110 and the bypass pipe 140 together may be mounted as shown in FIG. 3.

In the above embodiments, liquid nitrogen is used as the operating fluid. However, all kinds of refrigerant may be used as the operating fluid, not limited to the above.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

1-6. (canceled)

7. An apparatus for supplying liquid nitrogen for a decompression device, comprising:
a liquid nitrogen supply line for introducing high-temperature, high-pressure liquid nitrogen into a decompression device;
a bypass pipe diverging from the liquid nitrogen supply line; and
an expansion unit installed on the bypass pipe capable of evaporating liquid nitrogen into nitrogen gas,
wherein the expansion unit is capable of absorbing heat from liquid nitrogen in the liquid nitrogen supply line before the liquid nitrogen is introduced to the decompression device.

8. The apparatus for supplying liquid nitrogen for a decompression device according to claim 7, wherein the liquid nitrogen supply line passes through the expansion unit.

9. The apparatus for supplying liquid nitrogen for a decompression device according to claim 7,
wherein a first valve for opening or closing the liquid nitrogen supply line is further installed in the liquid nitrogen supply line, and
wherein a second valve for opening or closing the bypass pipe is further installed in the bypass pipe.

10. The apparatus for supplying liquid nitrogen for a decompression device according to claim 7, wherein an exhaust pipe extends from the expansion unit.

11. The apparatus for supplying liquid nitrogen for a decompression device according to claim 9, wherein the first valve and the second valve are linked to be opened and closed together.

12. The apparatus for supplying liquid nitrogen for a decompression device according to claim 7, wherein the expansion unit is capable of discharging the nitrogen gas at atmospheric pressure.
